(19) United States
(12) Patent Application Publication
(10) Pub. No.: US 2019/0361608 A1
(43) Pub. Date: Nov. 28, 2019

(54) DATA STORAGE DEVICE AND OPERATION METHOD FOR RECOVERY, AND STORAGE SYSTEM HAVING THE SAME

(71) Applicant: SK hynix Inc., Gyeonggi-do (KR)

(72) Inventor: Byung Jun KIM, Gyeonggi-do (KR)

(21) Appl. No.: 16/157,650

(22) Filed: Oct. 11, 2018

(30) Foreign Application Priority Data
May 24, 2018 (KR) 10-2018-0059176

(51) Int. Cl. G06F 3/06; G06F 12/02

(52) U.S. Cl. CPC G06F 3/065; G06F 3/0604; G06F 3/061; G06F 2212/1032; G06F 3/064; G06F 3/0673; G06F 12/0253; G06F 3/0619

(57) ABSTRACT

A data storage device includes a storage configured to include a storage configured to include a storage area divided into a plurality of blocks; and a controller configured to control a data input/output operation for the storage, collect recovery information including information on a block in use, among the plurality of blocks, and control a garbage collection operation based on the information on the block in use.

### CROSS-REFERENCE TO RELATED APPLICATION

The present application claims priority under 35 U.S.C. § 119(a) to Korean application number 10-2018-0059176, filed on May 24, 2018, which is incorporated herein by reference in its entirety.

### BACKGROUND

### 1. Technical Field

Various embodiments generally relate to a semiconductor integrated device, and, more particularly, to a data storage device and an operation method optimized for recovery performance, and a storage system having the same.

### 2. Related Art

A flash memory supports large capacity, and its demand is continuing to increase due to its nonvo at lity, low cost, low power consumption, high speed data processing speed, and the like.

A storage medium using the flash memory may be implemented in a solid state drive (SSD) type substituting for a hard disk, an embedded type available as an embedded memory, a mobile type, and the like. Moreover, a storage medium may be applied to various electronic appliances such as an electronic device, a vehicle navigation system, and a black box which mainly process multimedia data.

Such a data storage device requires sudden power off recovery (SPOR) for preventing or greatly reducing data loss or breakage of a drive or a partition, even though power is cut off during writing or reading of data.

For example, after sudden power off, when power is supplied again and a system is restarted, it is necessary for the system to return to a state just before the sudden power off and to perform data retention such that data stored before the sudden power off is not lost.

In addition, it is also necessary to return to a state of the data storage device at a specific time in response to a request of a host or a user during the use of the data storage device.

### SUMMARY

In an embodiment, a data storage device optimized for recovery performance may include: a storage configured to include a storage area divided into a plurality of blocks; and a controller configured to control a data input/output operation for the storage, collect recovery information including information on a block in use, among the plurality of blocks, and control a garbage collection operation based on the information on the block in use.

In an embodiment, an operation method of a data storage device including a storage having a storage area divided into a plurality of blocks and a controller that controls data exchange for the storage, the operation method comprising: collecting recovery information on the data storage device inclusive of information on a block in use among the plurality of blocks; and performing a garbage collection operation based on the information on the block in use in response to a garbage collection command.

In an embodiment, storage system comprising: a host device; and a data storage device including a storage having a storage area divided into a plurality of blocks and a controller that controls a data input/output operation for the storage at a request of the host device, wherein the controller is configured to collect recovery information including information on a block in use, among the plurality of blocks, and control a garbage collection operation based on the information on the block in use.

In an embodiment, a data storage device comprising: a storage including a plurality of blocks; and a controller configured to collect recovery information including information regarding a block in use, among the plurality of blocks, at a checkpoint time, and perform a garbage collection operation based on the information on the using block.

### BRIEF DESCRIPTION OF THE DRAWINGS

FIG. 1 is a schematic diagram of a data storage device in accordance with an embodiment.

FIG. 2 is a schematic diagram of a controller in accordance with an embodiment.

FIG. 3 is a diagram illustrating an example of division of a data storage area in a storage in accordance with an embodiment.

FIG. 4 is a diagram illustrating an example of data stored in a meta block in accordance with an embodiment.

FIG. 5 is a diagram illustrating an example of data stored in a checkpoint block in accordance with an embodiment.

FIG. 6 is a flowchart illustrating an operation method of a data storage device in accordance with an embodiment.

FIG. 7 is a diagram illustrating a garbage collection method of a data storage device in accordance with an embodiment.

FIG. 8 is a diagram illustrating a data storage system in accordance with an embodiment.

FIG. 9 and FIG. 10 are diagrams illustrating examples of a data processing system in accordance with an embodiment.

FIG. 11 is a diagram illustrating a network system including a data storage device in accordance with an embodiment.

FIG. 12 is a block diagram illustrating a nonvolatile memory device included in a data storage device in accordance with an embodiment.

### DETAILED DESCRIPTION

A data storage device and an operation method optimized for recovery performance, and a storage system having the same will be described below with reference to the accompanying drawings through various embodiments. Throughout the specification, reference to “an embodiment” or the like is not necessarily to only one embodiment, and different references to any such phrase are not necessarily to the same embodiment(s).

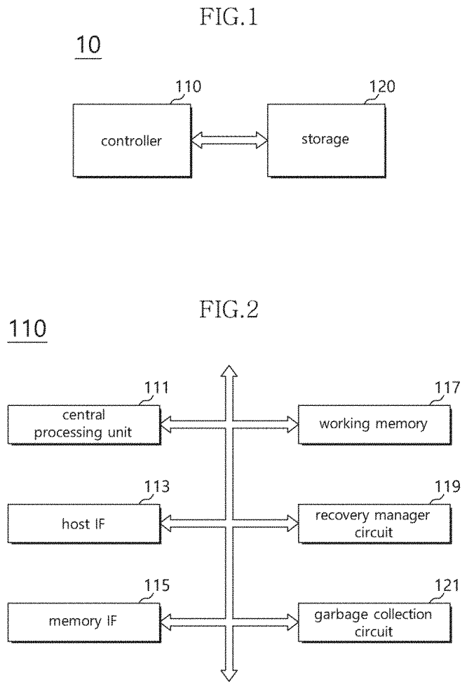

FIG. 1 is a schematic diagram of a data storage device in accordance with an embodiment.

Referring to FIG. 1, the data storage device 10 may include a controller 110 and a storage 120.

The controller 110 may control the storage 120 in response to a request received from a host device (not shown). For example, the controller 110 may control data to be programmed in the storage 120 in response to a program (or write) request of the host device. Furthermore, the controller 110 may provide the data stored in the storage 120 to the host device in response to a read request of the host device.

The storage 120 may write data or output the written data under the control of the controller 110. The storage 120 may include a volatile or nonvolatile memory device. In an embodiment, the storage 120 may be implemented using a memory device selected from various nonvolatile memory devices such as an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-MRAM). The storage 120 may include a plurality of dies, a plurality of chips, or a plurality of packages. In addition, the storage 120 may include a single-level cell that stores one-bit data in one memory cell or a multi-level cell that stores multi-bit data in one memory cell.

The storage 120 may have a hierarchical structure including a page including a plurality of memory cells, a block including at least one page, a plane including at least one block, a die including at least one plane, and the like. Read and write (or program) operations may be performed in units of pages for example, and an erase operation may be performed in units of blocks for example. In order to improve a data input/output speed, a unit of data to be read or written may be determined based on suitable considerations.

Although not illustrated in the drawing, a buffer memory may be provided within or external to the controller 110. The buffer memory may serve as a space or cache area capable of temporarily storing data when the data storage device 10 performs a series of operations, such as data writing or reading, in cooperation with the host device.

In an embodiment, the controller 110 may collect recovery information, that is, checkpoint information, in order to support recovery or return to a specific time point. The collected checkpoint information may be stored in a checkpoint block which is a pre- allocated area in the storage 120.

An operation for collecting the checkpoint information, that is, a checkpointing operation, may be a backup operation for storing in advance information required for booting operations of the data storage device 10.

In an embodiment, the checkpointing operation may be internally performed in the data storage device 10, that is, under the control of the controller 110 whenever a set or predefined situation or event occurs.

The information stored in the checkpoint block may be stored in a preset space of the storage 120, that is, a snapshot block, in response to a snapshot generation command. The snapshot generation command may be provided from the host device or a user; however, the present invention is not limited thereto. Accordingly, whenever a specific situation occurs, the checkpoint information may be stored in the checkpoint block, and when the snapshot generation command is triggered, the most recent checkpoint information at the trigger time point may be stored in the snapshot block.

In an embodiment of the present invention, the controller 110 may store information on a block in use as a part of the checkpoint information when the checkpointing operation is performed. The block in use may include all blocks, such as data blocks and map blocks, which are being used.

The controller 110 may also perform a garbage collection operation. When performing the garbage collection, the controller 110 may be configured to exclude blocks in use at a time during a checkpointing operation from candidates of victim blocks.

In the garbage collection, a block selected as the victim block is completely erased in a physical manner. Accordingly, if a block in use at a specific time point during the checkpointing operation (e.g., checkpointing operation time point) is actually erased, it is not possible to recover content of the already erased block when returning to the checkpointing operation time point. Accordingly, a block, which has been used at a time point at which recovery is possible, for example, a checkpointing operation time point, is excluded from an erase target, so that complete return to a specific time point is possible.

FIG. 2 is a configuration diagram of a controller 110 in accordance with an embodiment.

Referring to FIG. 2, the controller 110 may include a central processing unit (CPU), e.g., a processor, 111, a host interface (IF) 113, a memory interface (IF) 115, a working memory 117, a recovery manager circuit 119, and a garbage collection circuit 121.

The CPU 111 may be configured to transfer various types of is control information required for a data read or write operation for the storage 120 to the host interface 113, the memory interface 115, and the working memory 117. In an embodiment, the CPU 111 may operate according to firmware provided for various operations of the data storage device 10. In an embodiment, the CPU 111 may perform a function of a flash translation layer (FTL) for performing address mapping, wear leveling and the like for managing the storage 120. The CPU 111 may detect and correct an error of data read from the storage 120 according to its implementation. The function of detecting and correcting the error of the read data may be configured to be performed in a circuit separate from the CPU 111.

The host interface 113 may provide a communication channel for receiving a command and a clock signal from the host device (or a host processor) and controlling data input/output under the control of the CPU 111. Particularly, the host interface 113 may provide a physical connection between the host device and the data storage device 10 of FIG. 1. The host interface 113 may provide interfacing with the data storage device 10 in correspondence with a bus format of the host device. The bus format of the host device may include at least one of standard interface protocols such as a secure digital, a universal serial bus (USB), a multi-media card (MMC), an embedded MMC (eMMC), a personal computer memory card international association (PCMCIA), a parallel advanced technology attachment (PATA), a serial advanced technology attachment (SATA), a small computer system interface (SCSI), a serial attached SCSI (SAS), a peripheral component interconnection (PCI), a PCI express (PCI-e or PCIe), and a universal flash storage (UFS).

The memory interface 115 may provide a communication channel for signal transmission/reception between the controller 110 and the storage 120. The memory interface 115 may write data, which has been temporarily stored in the buffer memory, in the storage 120 under the control of the CPU 111. Furthermore, the memory interface 115 may transfer data read from the storage 120 to the buffer memory for temporary storage.

The working memory 117 may store program codes required for an operation of the controller 110, for example, firmware or software, and store code data and the like used by the program codes.

The CPU 111 may process a background operation at a specific or predefined time or time period, for example, while a request of the host device is being processed after the data storage device 10 is normally powered on, while its own process is being processed, or in an idle state. The background operation may include one or more of a garbage collection operation, a wear leveling operation, a read reclaim operation, and the like.

The recovery manager circuit 119 may manage the data storage device 10 to return to a system state before sudden power off when power is supplied again after the sudden power off and the data storage device 10 is restarted. Furthermore, the recovery manager circuit 119 may manage the data storage device 10 to return to a specific time point in response to a host or user's request during the use of the data storage device 10.

To this end, the recovery manager circuit 119 may collect the checkpoint information whenever a set or predefined situation or event occurs, and store the checkpoint information in the checkpoint block which is a pre-allocated area in the storage 120.

In an embodiment, the checkpoint information may include configuration information including channel (or way) information of the data storage device 10, map information, the number of open blocks, a next program position, the number of times of erase and write (E/W), and information on blocks in use. The checkpoint information may be stored in the checkpoint block together with a checkpoint version and a timestamp. The blocks in use may include a map block and a data block in use at the checkpointing operation time point.

As the snapshot generation command is triggered, the recovery manager circuit 119 may store the most recent checkpoint information at the trigger time point in the snapshot block which is a pre-allocated area in the storage 120. In an embodiment, the snapshot generation command may be provided from the host device or a user. The snapshot generation command may be triggered every set or predetermined cycle; however, the present invention is not limited thereto.

Accordingly, whenever a specific situation occurs, the checkpoint information may be collected and stored in the checkpoint block. Further, when the snapshot generation command is triggered, the most recent checkpoint information at the trigger time point may be stored in the snapshot block. In the checkpoint block, at least one piece of checkpoint information recently generated in chronological order may be substantially maintained. In the snapshot block, at least one piece of snapshot information recently generated in chronological order may be substantially maintained.

The garbage collection circuit 121 may be configured to ensure a free block in which data is writable. In an embodiment, the garbage collection circuit 121 may ensure the free block through a process for selecting a victim block, moving a valid page in the selected victim block to an arbitrary empty block (i.e., a target block), and erasing the victim block from which the valid page has been moved; however, the present invention is not limited thereto.

The garbage collection circuit 121 may refer to the information on blocks in use of the checkpoint information collected by the recovery manager circuit 119 when the victim block is selected in order to perform the garbage collection. For example, the garbage collection circuit 121 may be configured to exclude the blocks in use at the checkpointing operation time point from a candidate of the victim block.

Accordingly, a block corresponding to the information on blocks in use included in the at least one piece of snapshot information substantially maintained in the snapshot block is not selected as the victim block.

In the garbage collection, a block selected as the victim block is physically and completely erased. In the present technology, a map block and a data block, which are being used when the checkpoint information is generated, may be protected from an erase operation during the retention of the checkpoint information, so that it is possible to completely return to a specific time point at which the checkpoint information has been generated.

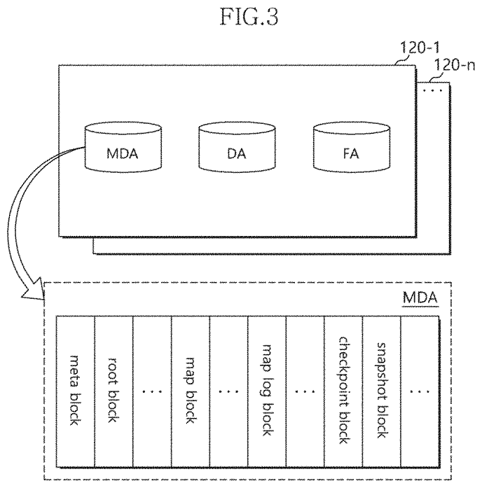

FIG. 3 is a diagram illustrating data stored in a storage array in accordance with an embodiment.

Referring to FIG. 3, storage elements 120-1 to 120-n may include a plurality of dies, a plurality of chips, or a plurality of packages. Each of the storage elements 120-1 to 120-n may include a meta data area MDA, a data area DA, and a free block area FA.

The meta data area MDA may be an area for storing information required when the controller 110 of FIG. 1 manages the storage 120. The data area DA may be a space for storing user data. The free block area FA may be a set of unused empty blocks.

The meta data area MDA may include a plurality of blocks, such as a meta block, a root block, a page map block, a map log block, a checkpoint block, a snapshot block and the like.

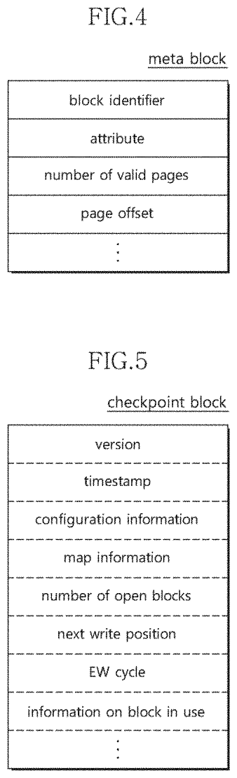

FIG. 4 is a diagram illustrating an example of data stored in a meta block in accordance with an embodiment.

Referring to FIG. 4, the meta block may be an area for storing meta information of each block. The meta block may employ a block identifier such as a physical address of a block as an index is and store information including an attribute of a corresponding block, the number of valid pages, a page offset and the like. The attribute of the block may be information indicating a state of the block, for example, information indicating whether the block is an open block, a closed block, or a free block.

The open block may indicate a memory block currently in use in order to process a write request. The closed block may indicate a block having no empty space capable of storing data or a block set not to store data. The free block may indicate an empty block in which data is writable..

The number of valid pages may be information indicating the number of valid pages included in each block.

The page offset may indicate offset information of a page to be subsequently written in a corresponding block.

Referring again to FIG. 3, the root block may be a space for storing information on the meta block. The map block may be a space for storing address mapping information between a logical page and a physical page. The map log block may be a space for collecting update information of the map block in a log format and storing the update information.

The checkpoint block may be a space for storing checkpoint information collected when a set or predefined situation or event occurs,

Referring to FIG. 5, the checkpoint information may include configuration information of the data storage device 10, map information, the number of open blocks, a next program position in a block, erase and write (EW) cycles, and information on blocks in use. The checkpoint information may be stored in the checkpoint block together with a checkpoint version and a timestamp. The blocks in use may include a map block and a data block in use at the checkpointing operation time point.

Referring again to FIG. 3, the snapshot block may be a space for storing the most recent checkpoint information at the trigger time point of the snapshot generation command. In an embodiment, the snapshot generation command may be provided from the host device or a user. The snapshot generation command may be triggered every set or predetermined cycle; however, the present invention is not limited thereto.

Accordingly, when a system (or a data storage device) is restarted after sudden power off or when the system should return to a specific time point at a request of a host or a user, it is possible to return or recover the system on the basis of the information stored in the snapshot block, or the information stored in the checkpoint block according to situations.

Moreover, blocks in use at the checkpointing operation time point may be excluded from an erase target, so that complete return to the specific time point is possible.

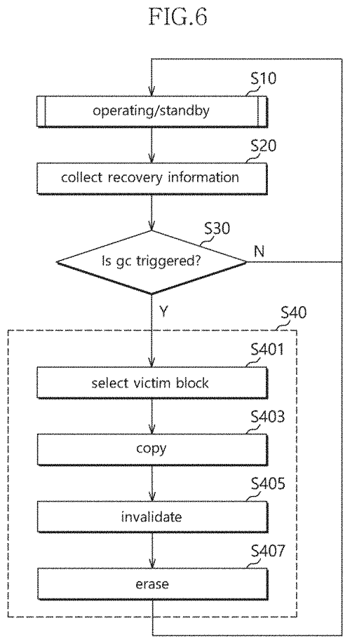

FIG. 6 is a flowchart illustrating an operation method of a data storage device in accordance with an embodiment. The operation of FIG. 6 may be performed by the controller 110 of the data storage device 10 in FIGS. 1 and 2.

Referring to FIG. 6, while the data storage device 10 is operating or is in a standby state (S10), the recovery manager circuit 119 of the controller 110 may collect recovery information capable of supporting system recovery (S20). In an embodiment, as an applicable or preset situation or event occurs, the controller 110 may collect the checkpoint information and store the collected checkpoint information in the checkpoint block. Furthermore, in response to the snapshot generation command provided from a host device or a user, the controller 110 may store the most recent checkpoint information at that time point in the snapshot block.

The garbage collection circuit 121 of the controller 110 may monitor whether the garbage collection (GC) command is triggered (S30).

When the garbage collection command is triggered (S30, Y), a garbage collection operation (S40) may be performed by the garbage collection circuit 121. The specifics of the garbage collection operation may be set in advance. When the garbage collection command is not triggered (S30, N), the data storage device 10 may be transitioned to the previous operation state or the standby state.

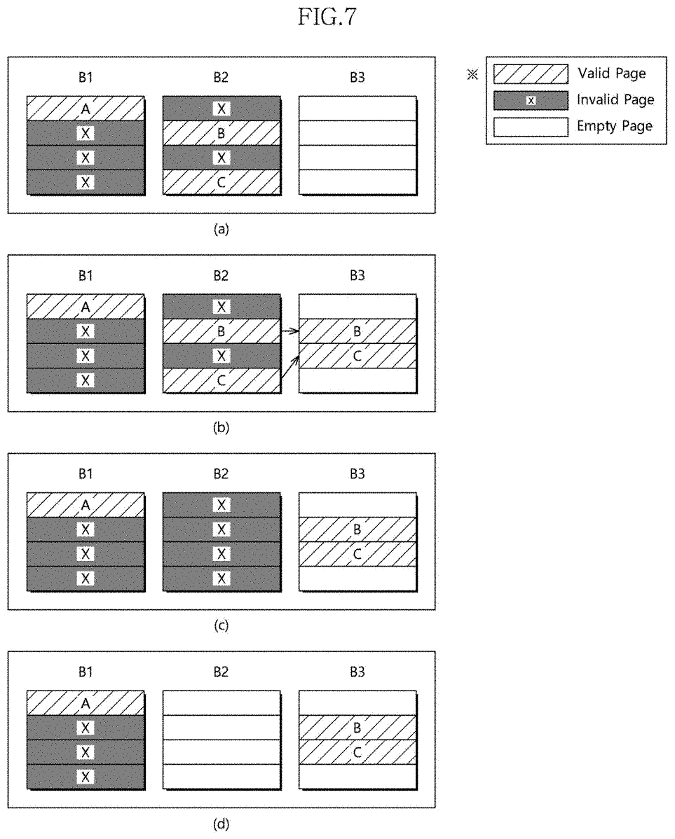

The garbage collection operation will be described with reference to FIG. 6 and FIG. 7.

FIG. 7 is a diagram illustrating a garbage collection method of a data storage device in accordance with an embodiment.

Referring to FIG. 6 and FIG. 7, in the GC operation (S40), a victim block may be first selected for the garbage collection (S401).

As illustrated in (a) of FIG. 7, a plurality of open blocks B1 and B2, and an empty block B3, which include a valid page, an invalid page and an empty page, may exist in the data area DA of the storage 120. The garbage collection circuit 121 may select at least one of the open blocks B1 and B2 as the victim block. In this case, the garbage collection circuit 121 excludes blocks in use at the checkpointing operation time point from the victim block with reference to the checkpoint information. For example, when the open block B1 is in use at the checkpointing operation time point, the open block B1 and a map block related to the open block B1 are not selected as the victim block.

The open block B2, which does not belong to the blocks in use at the checkpointing operation time point, may be selected as the victim block, and the garbage collection circuit 121 may copy information B and C on valid pages included in the open block B2 into the empty block B3 as illustrated in (b) of FIG. 7 (S403).

Then, the garbage collection circuit 121 invalidates the pages copied into the empty block B3 from the open block B2 (S405) ((c) of FIG. 7).

Subsequently, the garbage collection circuit 121 erases the open block B2 including only the invalid pages to generate an empty block (S407) ((d) of FIG. 7).

As a consequence, the block B1, which is in use at the collection time point of the checkpoint information, still remains is without being erased after the garbage collection. Consequently, when returning to the collection time point of the checkpoint information or the generation time point of the snapshot information from the checkpoint information, it is possible to restore information on the block B1 without loss.

FIG. 8 is a diagram illustrating a data storage system 1000 in accordance with an embodiment. Referring to FIG. 8, the data storage system 1000 may include a host device 1100 and a data storage device 1200. In an embodiment, the data storage device 1200 may be configured to a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface, a control component, a random access memory used as a working memory, an error correction code (ECC) component, and a memory interface. In an embodiment, the controller 1210 may be implemented by the controller 110 comprising the recovery manager circuit 119 as shown in FIGs.1 and 2.

The host device 1100 may exchange a signal with the data storage device 1200 through the signal connector 1101. The signal may include a command, an address, data, and so forth.

The controller 1210 may analyze and process the signal received from the host device 1100. The controller 1210 may control operations of internal function blocks according to a firmware or a software for driving the data storage device 1200.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power inputted through the power connector 1103, to the inside of the data storage device 1200. The power supply 1240 may include an auxiliary power supply. The auxiliary power supply may supply power to allow the data storage device 1200 to be properly terminated when a sudden power-off occurs. The auxiliary power supply may include large capacity capacitors.

The signal connector 1101 may be configured as any of various types of connectors depending on an interface scheme between the host device 1100 and the data storage device 1200.

The power connector 1103 may be configured as any of various types of connectors depending on a power supply scheme of the host device 1100.

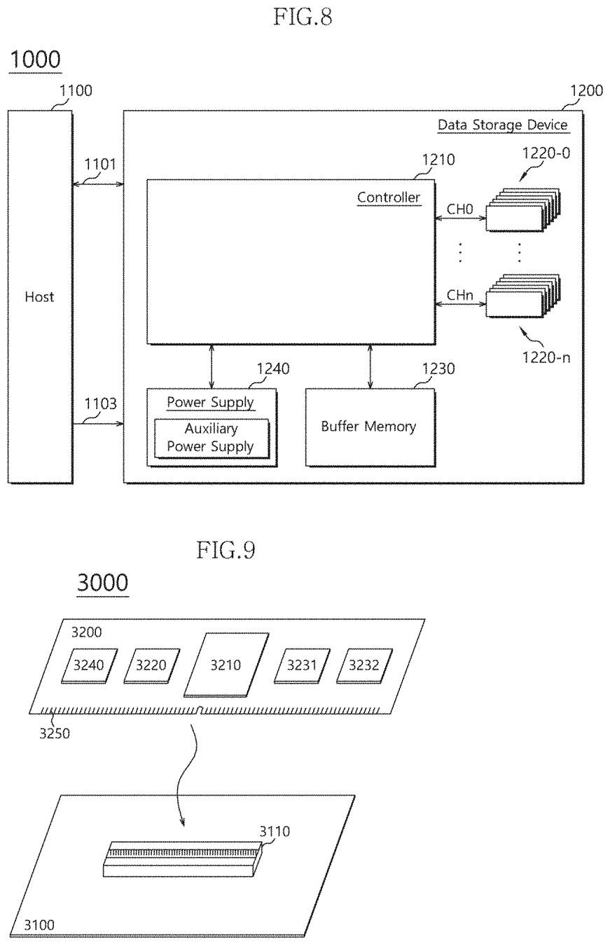

FIG. 9 is a diagram illustrating a data processing system 3000 in accordance with an embodiment. Referring to FIG. 9, the data processing system 3000 may include a host device 3100 and a memory system 3200.

The host device 3100 may be configured in the form of a board such as a printed circuit board. Although not shown, the host device 3100 may include internal function blocks for performing the function of a host device.

The host device 3100 may include a connection terminal 3110 such as a socket, a slot or a connector. The memory system 3200 may be mounted to the connection terminal 3110.

The memory system 3200 may be configured in the form of a board such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be implemented in the same manner as the controller 110 comprising the recovery manager circuit 119 as shown in FIGS. 1 and 2.

The buffer memory device 3220 may temporarily store data to be stored in the nonvolatile memory devices 3231 and 3232. Further, the buffer memory device 3220 may temporarily store the data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250, to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data and so forth and power may be transferred between the host device 3100 and the memory system 3200. The connection terminal 3250 may be configured as any of various types depending on an interface scheme between the host device 3100 and the memory system 3200. The connection terminal 3250 may be disposed on any one side of the memory system 3200.

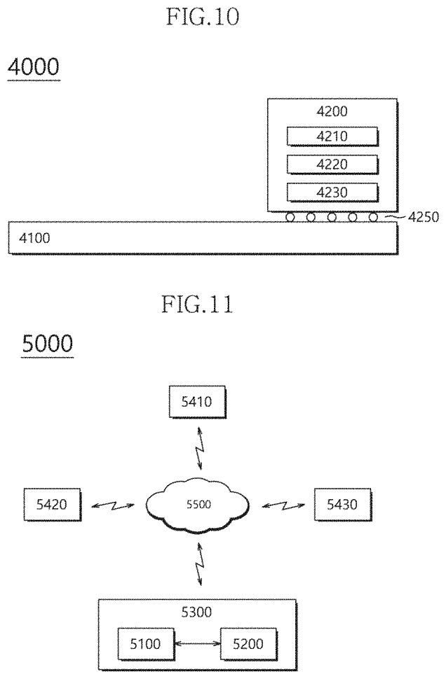

FIG. 10 is a diagram illustrating a data processing system 4000 in accordance with an embodiment. Referring to FIG. 10, the data processing system 4000 may include a host device 4100 and a memory system 4200.

The host device 4100 may be configured in the form of a board such as a printed circuit board. Although not shown, the host device 4100 may include internal function blocks for performing the function of a host device.

The memory system 4200 may be configured in the form of a surface-mounting type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 comprising the recovery manager circuit 119 as shown in FIGs, 1 and 2.

The buffer memory device 4220 may temporarily store data to be stored in the nonvolatile memory device 4230. Further, the buffer memory device 4220 may temporarily store the data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

FIG. 11 is a diagram illustrating a network system 5000 including a data storage device in accordance with an embodiment. Referring to FIG. 11, the network system 5000 may include a server system 5300 and a plurality of client systems 5410 to 5430 which are coupled through a network 5500.

The server system 5300 may service data in response to requests from the plurality of client systems 5410 to 5430. For example, the server system 5300 may store the data provided from the plurality of client systems 5410 to 5430. For another example, the server system 5300 may provide data to the plurality of client systems 5410 to 5430.

The server system 5300 may include a host device 5100 and a memory system 5200. The memory system 5200 may be implemented by the memory system 10 shown in FIG. 1, the data storage device 1200 shown in FIG. 8, the memory system 3200 shown in FIG. 9 or the memory system 4200 shown in FIG. 10.

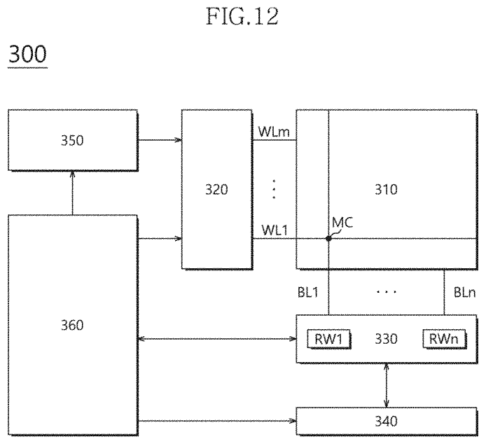

FIG. 12 is a block diagram illustrating a nonvolatile memory device 300 included in a data storage device in accordance with an embodiment. Referring to FIG. 12, the nonvolatile memory device 300 may include a memory cell array 310, a row decoder 320, a data read and write (read/write) block 330, a column decoder 340, a voltage generator 350, and a control logic 360.

The memory cell array 310 may include memory cells MC which are arranged at areas where word lines WL1 to WLm and bit lines BL1 to BLn intersect with each other.

The memory cell array 310 may comprise a three-dimensional memory array. The three-dimensional memory array has a direction perpendicular to the flat surface of a semiconductor substrate. Moreover, the three-dimensional memory array means a structure including NAND strings which at least memory cell is located in a vertical upper portion of the other memory cell.

The structure of the three-dimensional memory array is not limited thereto. It is apparent that the memory array structure can be selectively applied to a memory array structure formed in a highly integrated manner with horizontal directionality as well as vertical directionality.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300.

The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

While various embodiments have been described above, it will be understood by those skilled in the art that variations and modifications are possible. Accordingly, the present invention is no limited based on the described embodiments. Rather, the present invention encompasses all variations and modifications that fall within the scope of the claims.

What is claimed is:

1. A data storage device, comprising:
a storage configured to include a storage area divided into a plurality of blocks; and
a controller configured to control a data input/output operation for the storage, collect recovery information including information on a block in use, among the plurality of blocks, and control a garbage collection operation based on the information on the block in use.

2. The data storage device according to claim 1, wherein the controller is configured to control the block in use to be excluded from the garbage collection operation.

3. The data storage device according to claim 1, wherein the block in use includes a data block and a map block in use when the recovery information is collected.

4. The data storage device according to claim 1, wherein the controller includes a recovery manager circuit configured to collect the recovery information including the information on the block in use, to store the recovery information in a checkpoint block, and to store snapshot information generated from the checkpoint block in a snapshot block.

5. The data storage device according to claim 4, wherein the checkpoint block stores at least one piece of recovery information and the snapshot block stores at least one piece of snapshot information.

6. The data storage device according to claim 4, wherein the recovery information includes information on a data block in use when the recovery information is collected, information on a map block in use when the recovery information is collected, configuration information of the data storage device, map information, a number of open blocks, a next program position in a block, and information on erase and write cycles.

7. The data storage device according to claim 6, wherein the recovery information further includes information on a version and a timestamp of the recovery information.

8. An operation method of a data storage device including a storage having a storage area divided into a plurality of blocks and a controller that controls data exchange for the storage, the operation method comprising:
collecting recovery information on the data storage device inclusive of information on a block in use among the plurality of blocks; and
performing a garbage collection operation based on the information on the block in use in response to a garbage collection command.

9. The operation method according to claim 8, wherein the performing of the garbage collection operation comprises:
controlling the block in use to be excluded from the garbage collection operation.

10. The operation method according to claim 8, wherein the block in use includes a data block and a map block in use when the recovery information is collected.

11. The operation method according to claim 8, wherein the collecting of the recovery information comprises:
collecting the recovery information including the information on the block in use and storing the recovery information in a checkpoint block; and
storing snapshot information generated from the checkpoint block in a snapshot block.

12. The operation method according to claim 11, wherein the checkpoint block stores at least one piece of recovery information and the snapshot block stores at least one piece of snapshot information.

13. The operation method according to claim 11, wherein the recovery information includes information on a data block in use when the recovery information is collected, information on a map block in use when the recovery information is collected, configuration information of the data storage device, map information, a number of open blocks, a next program position in a block, and information on erase and write cycles.

14. The operation method according to claim 13, wherein the recovery information further includes information on a version and a timestamp of the recovery information.

15. A storage system comprising:
a host device; and
a data storage device including a storage having a storage area divided into a plurality of blocks and a controller that controls a data input/output operation for the storage at a request of the host device,
wherein the controller is configured to collect recovery information including information on a block in use, among the plurality of blocks, and control a garbage collection operation based on the information on the block in use.

16. The storage system according to claim 15, wherein the controller is configured to control the block in use to be excluded from the garbage collection operation.

17. The storage system according to claim 15, wherein the block in use includes a data block and a map block in use when the recovery information is collected.

18. The storage system according to claim 15, wherein the controller is configured to include a recovery manager circuit configured to collect the recovery information including the information on the block in use, to store the recovery information in a checkpoint block, and to store snapshot information generated from the checkpoint block in a snapshot block.

19. The storage system according to claim 18, wherein the checkpoint block stores at least one piece of recovery information and the snapshot block stores at least one piece of snapshot information.

20. The storage system according to claim 18, wherein the recovery information includes information on a data block in use when the recovery information is collected, information on a map block in use when the recovery information is collected, configuration information of the data storage device, map information, a number of open blocks, a next program position in a block, information on erase and write cycles, and information on a version and a timestamp of the recovery information.

21. A data storage device comprising:
a storage including a plurality of blocks; and
a controller configured to collect recovery information including information regarding a block in use, among the plurality of blocks, at a checkpoint time, and perform a garbage collection operation based on the information on the using block.

22. The data storage device according to claim 21, wherein the controller configured to perform the garbage collection operation on at least one victim block excluding the block in use.
